(19) United States
(12) Patent Application Publication
(10) Pub. No.: US 2006/0250414 A1
(43) Pub. Date: Nov. 9, 2006

(54) System and method of anti-aliasing computer images

(76) Inventor: Vladimir Golovin, Rostov-na-Donu (RU)

Correspondence Address: GIBBONS, DEL DEO, DOLAN, GRIFFINGER & VECCHIONE, 1 RIVERFRONT PLAZA, NEWARK, NJ, 07102-5497, US

(21) Appl. No.: 11/120,849

(22) Filed: May 3, 2005

(51) Int. Cl. G09G 5/00

(52) U.S. Cl. 345/611

(57) ABSTRACT

The present invention relates to systems and methods for anti-aliasing computer images. Specifically, the present invention is a method and a system for generating an image that includes the steps of: a) rendering a non-anti-aliased image having a region map, wherein the region map further comprises at least one continuous region; b) determining at least one boundary of the at least one continuous region; and c) anti-aliasing the at least one boundary to generate an anti-aliased image.

### BACKGROUND OF THE INVENTION

1. Field of the Invention

This invention relates to computer graphics, and more particularly to image synthesis, image generation and visualization. Specifically, the present invention relates to systems and methods for anti-aliasing of images.

2. Background

Conventional computer, software and hardware systems include graphics systems or subsystems that interact with data and commands to generate an image consisting of a plurality of pixels. One of the ways to define an image is by its underlying mathematical representation, such as a function that defines a plurality of curves or polygons, 3D models, textures, or any combination thereof. In this case, the image is produced by “sampling” the underlying representation. This is done by obtaining a color of each pixel by evaluating the underlying representation at least once at coordinates corresponding to each pixel. “Sampling” is a conversion of a continuous-space signal (an image function) into a discrete-space signal (a plurality of pixels). The above underlying mathematical representation of the image is called an image function.

Since the process of generating an image which is defined by an image function involves sampling, unwanted effects such as “aliasing” may appear in the image. Aliasing appears as jaggedness, unevenness or Moire patterns that are especially visible in the areas of the image corresponding to discontinuities in the original continuous-space signal, i.e., the image function. Further, aliasing is caused by frequencies which exceed the Nyquist limit. The Nyquist limit specifies that the original signal can be appropriately reconstructed from samples only if the sampling frequency is at least twice the maximum frequency of the original signal. Since discontinuities in the original signal create infinitely high frequencies, aliasing is most apparent at the boundaries between continuous regions of the image function. Examples of such boundaries are edges between polygons in a 3D model, conditional statements inside a shader code, or contours of a 2D polygon or curve.

Hence, for the boundaries to appear smooth, anti-aliasing needs to be applied. This can include evaluating the image function multiple times per pixel.

Conventional anti-aliasing techniques apply anti-aliasing to every pixel of the image. In other words, the anti-aliasing applies to continuous regions and discontinuities equally. This is inefficient, because continuous regions do not benefit from anti-aliasing. The result is that continuous areas will appear the same to a human eye as they were before the anti-aliasing was applied. On the other hand, the boundaries of the continuous regions of the image will benefit from the anti-aliasing.

Hence, there is a need for a system and a method capable of alleviating expensive anti-aliasing techniques that anti-alias both continuous regions and discontinuities of the image function. Further, there is a need for a system and a method that selectively applies anti-aliasing to discontinuities of the image function.

### BRIEF SUMMARY OF THE INVENTION

The present invention relates to system and method of anti-aliasing of computer images. Specifically, in an embodiment, the present invention is a method for generating an image. The method includes the steps of a) rendering a non-anti-aliased image having a region map, wherein the region map further includes at least one continuous region; b) determining at least one boundary of the at least one continuous region; and c) anti-aliasing the at least one boundary to generate an anti-aliased image.

In an alternate embodiment, the present invention is a method for generating an image of a model. The method includes the following steps: a) projecting a model into image space; b) identifying at least one continuous region based on said projecting; c) determining at least one boundary of the at least one continuous region; and d) generating an anti-aliased image of the model, wherein generating further includes anti-aliasing the at least one boundary.

In yet an alternate embodiment, the present invention is a method for anti-aliasing an image. The method includes the following steps: a) generating a non-anti-aliased image defined using an image function; b) locating at least one continuous region defined using the image function, wherein the at least one continuous region has at least one boundary; and c) generating an anti-aliased image, wherein generating further includes anti-aliasing the at least one boundary.

In yet another alternate embodiment, the present invention is a system for anti-aliasing an image. The system is configured to perform method steps described above.

Further features and advantages of the invention, as well as structure and operation of various embodiments of the invention are disclosed in detail below and with reference to the accompanying drawings.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1a illustrates an example of a non-anti-aliased image.

FIG. 1a illustrates an example of an anti-aliased image.

FIG. 2a illustrates a non-anti-aliased image generated by an image function.

FIG. 2b illustrates a Region Map of the non-anti-aliased image shown in FIG. 2a generated by a modified image function, according to the present invention.

FIG. 2c illustrates an Edge Map of the non-anti-aliased image shown in FIG. 2a generated by a modified image function, according to the present invention.

FIG. 2d illustrates an anti-aliased image produced from the non-anti-aliased image shown in FIG. 2a and the Edge Map shown in FIG. 2c, according to the present invention.

FIG. 3 is a flow chart of an embodiment of a method for generating an anti-aliased image, according to the present invention.

FIG. 4 is a flow chart of an alternate embodiment of a method for generating an anti-aliased image, according to the present invention.

FIG. 5 is a flow chart of yet another alternate embodiment of a method for generating an anti-aliased image, according to the present invention.

FIG. 6 illustrates a system for generating an anti-aliased image, according to the present invention.

FIG. 7a is a flow chart showing a path of execution flow through conditional statements in an exemplary image function.

FIG. 7b is a flow chart showing another example of a path of execution flow through conditional statements in the exemplary image function shown in FIG. 7a.

FIG. 7c is a flow chart showing yet another example of a path of execution flow through conditional statements in the exemplary image function shown in FIG. 7a.

### DETAILED DESCRIPTION OF THE INVENTION

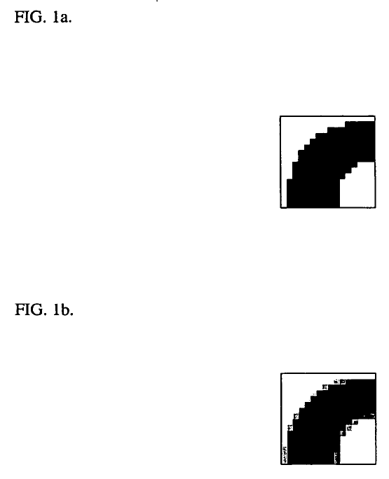

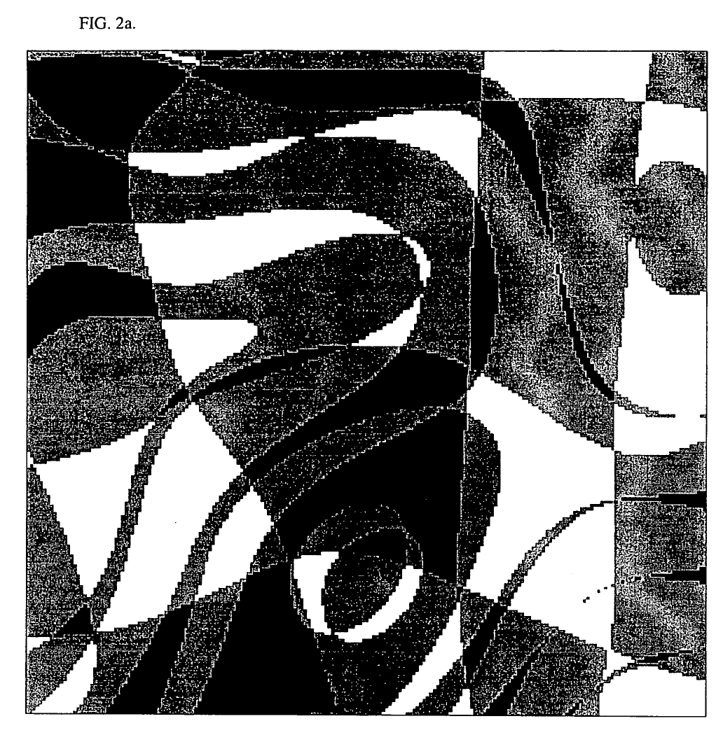

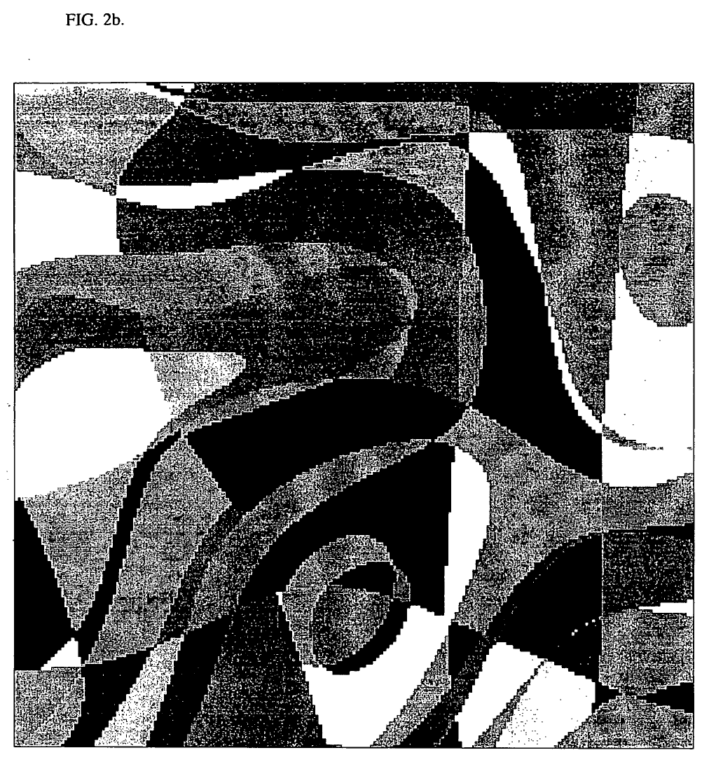

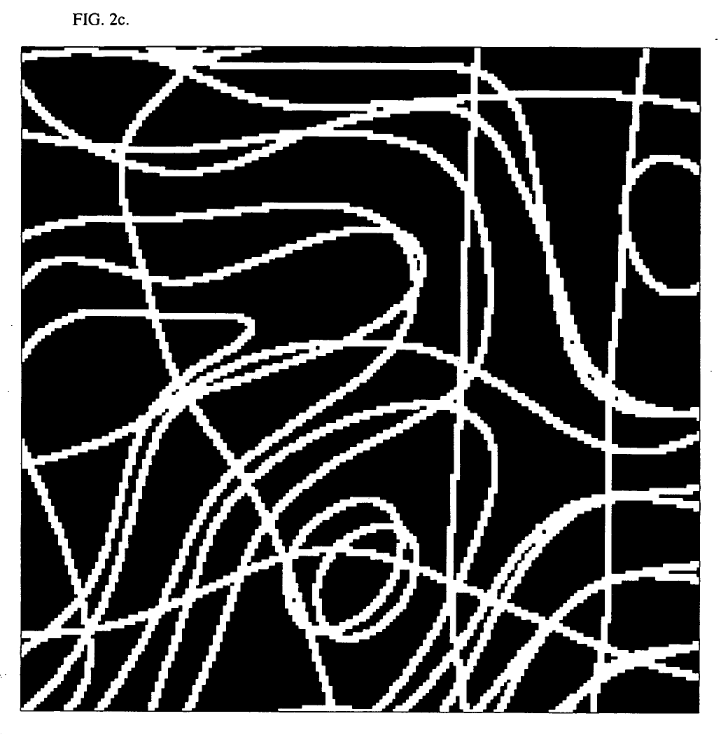

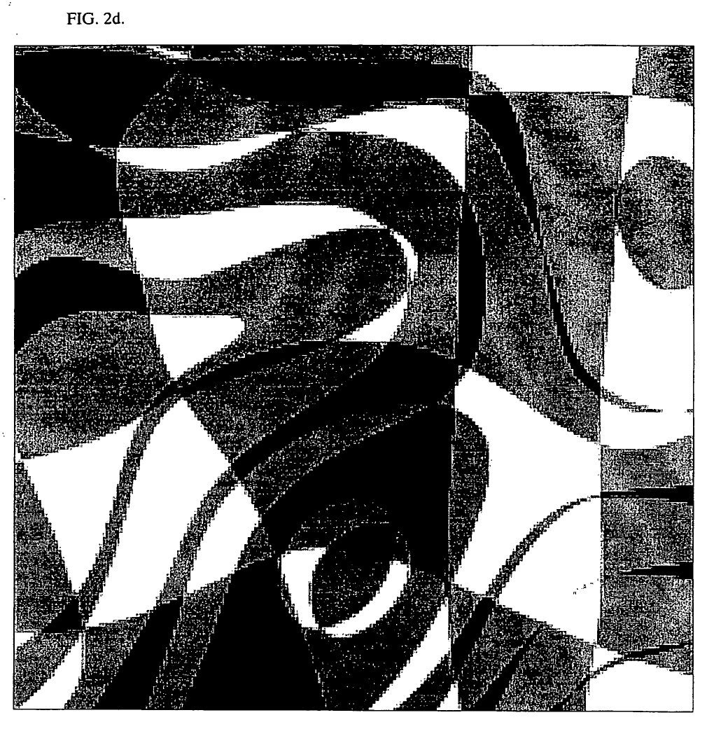

The present invention relates to computer graphics. Specifically, the present invention relates to image synthesis, image generation and visualization. The present invention allows faster generating of images having anti-aliased (or smooth) edges. In an embodiment, the present invention uses an image function in the form of color=f(x,y) to generate anti-aliased images, where x and y are defined in an image coordinate space. This generation is accomplished by generating a non-anti-aliased image, determining continuous regions within the image function, projecting the regions into an image space, applying an edge-finding convolution to the projection to find pixels overlapping with the edges between continuous regions, and applying anti-aliasing to those pixels only. For this purpose the image function is modified to be capable of identifying its continuous regions. One of the advantages of the present invention is that anti-aliasing is applied only to the above pixels instead of being applied to every pixel in a final image. Therefore, a significant amount of time is saved. FIG. 1a illustrates an example of a non-anti-aliased image. FIG. 1b illustrates an example of an anti-aliased image of FIG. 1a. FIGS. 2a-7c further illustrate methods and systems of the present invention in detail.

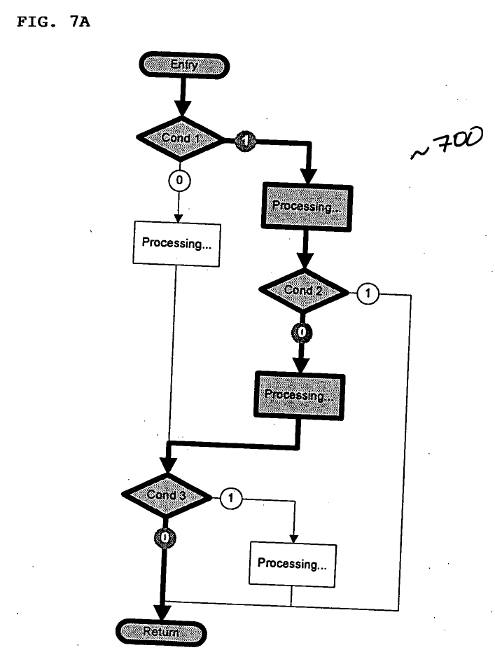

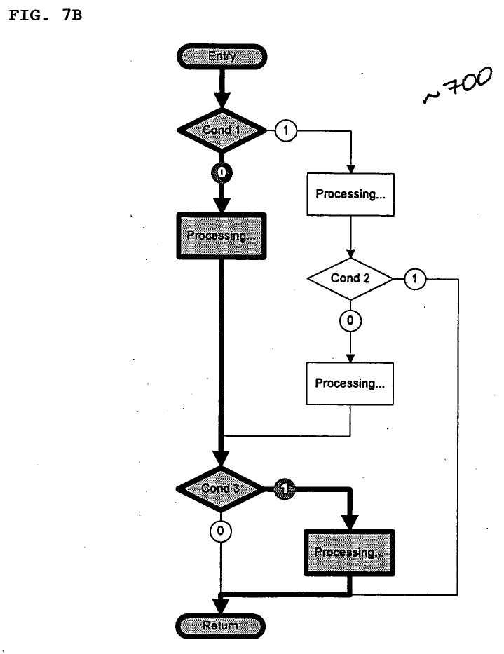

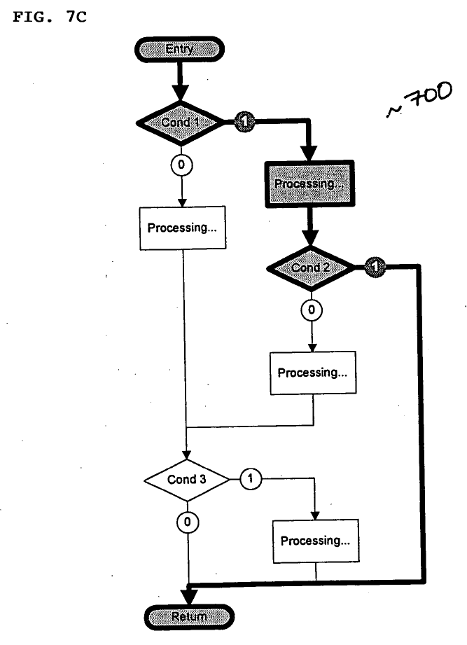

FIG. 2a illustrates a non-anti-aliased image generated by a modified image function f(x, y), according to the present invention. FIG. 2d illustrates an anti-aliased image generated by a modified image function f(x, y), according to an embodiment of the present invention. The image in FIG. 2a includes solid portions that have uneven or “jagged” edges. The edges cause the image to appear uneven. The image function contains conditional statements (shown in FIGS. 7a-c as diamond-shaped blocks titled Cond 1, Cond 2 and Cond 3), which require the image function to select a specific action or path of execution. Before and after conditional statements and in their branches, the image function performs processing to evaluate its output.

To make the image smoother and allow it to have undistorted edges, anti-aliasing is applied. The anti-aliasing is applied to the edges, as shown in FIG. 2c. Solid areas do not benefit from application of anti-aliasing, because they do not contain discontinuities caused by conditional statements since these areas are evaluated by following the same path through conditional statements in the image function. Further, because in many cases solid areas occupy most of the image, and the modifications to the image function which are proposed in this invention are relatively computationally inexpensive, limiting the application of anti-aliasing process to the boundaries of continuous regions can save a lot of expense and time. As such, the final anti-aliased image is rendered faster.

As stated above, the present invention is a system and a method of generating an anti-aliased image defined by an image function (shown in FIG. 2d) from a non-anti-aliased image (shown in FIG. 2a) using its region map (shown in FIG. 2b) and an edge map (shown in FIG. 2c).

According to the present invention, the image function that defines an image is modified so that it is capable of detecting continuous regions. These modifications are described below.

In an embodiment, an image function can perform the following steps to detect continuous regions: (1) generate a value identifying a continuous region at coordinates of a current image function sample, and (2) return the value along with a result of the image function (such as a color). The value identifying the continuous region is referred to as a RegionID. If two samples of the image function return the same RegionID, it means that both samples are located in the same continuous region. Therefore, if the samples were evaluated at coordinates corresponding to adjacent pixels, the pixels do not have discontinuities between them and do not require anti-aliasing.

During the image rendering process, a comparison of the RegionID values of adjacent pixels is performed to determine if the pixels are located in different continuous regions, and therefore overlap with at least one discontinuity. If RegionID values of two adjacent pixels do not match, then both pixels require anti-aliasing.

Since discontinuities are substantially caused by conditional statements inside the image function, a region in which all samples are evaluated following the same execution path through discontinuity-causing conditional statements can be considered continuous. Therefore, a value representing a captured path of the execution flow through the image function's discontinuity-causing conditional statements can be considered a unique identifier of a continuous region. Hence, this value can be used as RegionID.

However, if two samples follow the same execution path, it does not mean that they are located in the same continuous region. It is especially true for periodic or repeating functions (for example, a function representing a checkerboard), which can have an infinite number of continuous regions but only one discontinuity-causing conditional statement. Therefore, assuming that the calculation of the RegionID values is based on the captured path of the execution flow through discontinuity-causing conditional statements, such function can generate only two RegionID values (one for a TRUE branch of a conditional statement and one for a FALSE branch).

This can lead to a situation when two neighboring samples of the image function have the same RegionID value but are located in different continuous regions. In the checkerboard example, both samples can be located in “white squares,” separated by at least one “black square.” Since the RegionID value of both samples is the same, discontinuities located between these samples are not detected.

In such cases, additional properties can be incorporated into RegionID values to ensure that they are unique for each continuous region. For example, a RegionID value of a checkerboard image function can include coordinates of a square in which a sampling point is located. Since all squares have different coordinates, the RegionID value is unique for each continuous region (i.e., square).

Not every conditional statement causes discontinuity. For example, a raytracing-based renderer can use a spatial subdivision structure (e.g., quadtree, BSP tree, hierarchical bounding volumes, etc.) to accelerate its ray tracing function. Alternatively, a renderer can use a conditional statement to check if a texture is loaded into memory or not. Handling such tasks inevitably involves conditional statements, however, their effects are not visible in the final image. Thus, these statements do not cause discontinuities.

As such, in an embodiment, conditional statements are considered only if they cause discontinuities (or jagged edges) to appear in the image. Examples of discontinuity-causing conditional statements include: 1) branching in a checkerboard shader (determination whether a pixel is black or white); 2) hit tests in a ray tracer (determination whether a model contour was hit or not); 3) sharp ray-traced shadows (determination whether a point is lit by a light source or not); and others.

RegionID values can be stored for further comparison. Thus, a modified image function can return RegionID values in a storage-efficient format allowing comparison operations (for example, a determination of whether selected RegionID values are equal to each other). An example of such format is a finite numeric value represented by a fixed number of bits.

The modified image function is analyzed to find discontinuity-causing conditional statements based on the criteria described above. Then, additional instructions, or “triggers”, are added to every branch of each discontinuity-causing conditional statement. The purpose of these triggers is to determine which branch was executed and to contribute this information to the captured execution path.

The analysis and addition of triggers can be performed manually and/or automatically. For example, in a software environment, a manual analysis of an image function in a software embodiment can be performed by examining a software source code of the image function. Similarly, a manual addition of triggers can be performed by altering the image function's source code before compilation. In a hardware environment, such as a video card or a graphic processing unit, the automatic analysis can be performed during a shader compilation by selecting conditional operators that affect an output of the shader. The automatic addition of triggers can be performed by a compiler by inserting a trigger code into branches of appropriate conditional statements.

A binary string of variable length (such as a sequence of binary digits “111001101”) can be used to define captured path. The length can be variable because the number of executed conditional statements can vary from sample to sample. Some statements can terminate execution of the image function before the execution flow reaches other statements. In other cases, a conditional statement can be bypassed by other statements.

Initially, the binary string is empty and has zero length. When the execution flow passes a discontinuity-causing conditional statement, it reaches one of the triggers which have been added into branches of this statement. When the trigger is executed, it appends a predefined binary string to the captured path. The length of the captured path increases by the length of the appended string.

The purpose of this predefined binary string is to indicate which branch of a discontinuity-causing conditional statement is executed. Therefore, the value of this predefined binary string is unique for each branch of the conditional statement.

For example, in a two-branch conditional statement, such as “if” statement in the C/C++ programming language, the string “1” can be appended to the captured execution path to designate a TRUE branch of a conditional statement, and “0” to designate a FALSE branch.

For multi-branch conditional statements like a “switch” statement in the C/C++ programming language, the predefined binary string can correspond to the branch's number in a binary form. For example, “00” corresponds to the first branch, “01” corresponds to the second branch, “10” corresponds to the third branch, “11” corresponds to the fourth branch and so forth.

FIGS. 7a-c illustrate three calls to the same modified image function following different execution paths 700. The rectangular blocks denote processing operations which evaluate the image function's result (such as color or grayscale). The diamond-shaped blocks denote conditional statements that redirect the execution flow to either a TRUE branch or a FALSE branch. The circles show triggers, that is path-capturing instructions, added to every branch of discontinuity-causing conditional statements to capture the execution path. The filled circles indicate triggers, which contribute to the captured execution path for a given call. “1” in the circle indicates that the TRUE branch of a conditional statement was executed and a binary string “1” was appended to the captured path. “0” in the circle indicates that the FALSE branch of a conditional statement was executed and a binary string “0” was appended to the captured path.

For the call to the image function illustrated in FIG. 7a, the captured path is represented by a binary string “100” (according to the filled circles) and has a length equal to 3. For the call illustrated in FIG. 7b, the captured path is represented by a binary string “01” and has a length equal to 2. Finally, for the call illustrated in FIG. 7c, the captured path is represented by a binary string “11” and has a length equal to 2. In real-world image functions, such as surface shaders in a rendering application, a length of the captured path can be much greater.

As described above, an image function can have multiple continuous regions which are evaluated following the same execution path through discontinuity-causing conditional statements. For such functions, to ensure uniqueness of the RegionID values associated with continuous regions, the present invention generates a unique binary string for each such region. During an evaluation of the image function, the unique binary string is appended to the captured path. In the checkerboard function example, the binary string can include coordinates of a square. Since each square has unique coordinates, RegionID values for different squares will be unique.

In an embodiment, a hash function can be used to convert a captured execution path into a storage-efficient format that allows efficient comparison operations. The function condenses the captured path into a finite numeric value represented by a fixed number of bits. It returns values that can be efficiently stored in a bitmap-like memory structure for subsequent comparison. The result of the hash function is returned as a RegionID value along with the result of the image function (such as color or grayscale).

In an alternate embodiment, a cyclic redundancy check (“CRC”) calculation can be used to generate a value representing the captured path. The captured path here is not a binary string of variable length, but a result of a CRC calculation of all the contributions made by the triggers executed during evaluation of the image function. Also, instead of predefined binary strings, the triggers contribute predefined numeric values to the captured path. The CRC calculation's value is recalculated every time a trigger contributes to the captured path. This alleviates computational expenses associated with processing binary strings of variable length. Another advantage is that there is no need to evaluate a hash function to generate a RegionID value because the result of a CRC calculation is already a finite number represented by a fixed number of bits that can be returned as a RegionID value.

After the image function is modified as described above, it can calculate and return two values: 1) a result of the image function (color, grayscale, etc.); and 2) the RegionID value—a unique identifier of a continuous region at sample coordinates in a storage-efficient format, which allows efficient comparison operations.

Using the modified image function described above, the present invention performs rendering of an anti-aliased image. In an embodiment, the process includes the following steps or “rendering passes”: 1) rendering a non-anti-aliased image and its Region Map (i.e., a map of continuous regions within an image); 2) marking pixels for anti-aliasing by finding edges in the Region Map; and 3) applying anti-aliasing to the marked pixels.

Step 1: Rendering a Non-Anti-Aliased Image and Its Region Map.

As stated above, the image function is used to render an image which can be stored in a memory device, displayed on a display device, sent to an output device, or any combination thereof. For images defined by image functions, the rendering process includes evaluating (or “sampling”) the image function at coordinates corresponding to pixels in the image. The sampling process involves conversion of continuous-space signals into discrete-space signals. Generally, the image function is sampled at least once per pixel to obtain the color of this pixel.

In the present invention, initially, the modified image function is sampled once per pixel to generate a non-anti-aliased image and its “Region Map” (i.e., map of its continuous regions). The non-anti-aliased image is shown in FIG. 2a. Its Region Map is shown in FIG. 2b.

In the process, the modified image function returns color or grayscale values, which are stored in the non-anti-aliased image as pixels, and RegionID values, which are stored in the Region Map at the coordinates corresponding to the pixels. The Region Map is a projection of the continuous regions of the image function into an image space. A continuous region is a region in which all samples of the image function have identical RegionID values. Thus, continuous regions are represented by identical RegionID values in the Region Map.

The Region Map is defined in the image space and can have the same dimensions as the output image. The Region Map's bit depth (i.e., a number of bits per value stored) can be the same as that of the RegionID value. For example, if the image function returns RegionID as a 32-bit value, then the bit depth of the Region Map should be 32 bits.

Step 2: Marking Pixels for Anti-Aliasing by Finding Edges in the Region Map.

In the second step, or second rendering pass, an Edge Map of the image is created. Similarly to the Region Map (shown in FIG. 2b), the Edge Map is defined in the image space having the same dimensions. The purpose of the Edge Map is to indicate pixels that require anti-aliasing. If a pixel is marked in the Edge Map, a corresponding pixel in the non-anti-aliased image will be anti-aliased. The Edge Map for the non-anti-aliased image shown in FIG. 2a is illustrated in FIG. 2c.

To generate the Edge Map, an edge-finding convolution is applied to the Region Map generated in the first step. Such convolution detects pixels which are adjacent to the edges of each continuous region in the Region Map, and marks them in the Edge Map.

In an embodiment, the edge-finding convolution can be performed using the following algorithm: cycle through all pixels of the Region Map to find pixels that have at least one adjacent pixel of different value; and for every such pixel found, mark the corresponding pixel in the Edge Map. This algorithm is illustrated by the following computer pseudocode:

FOR CurrentPixel IN RegionMap

IF (any of the 8 pixels adjacent to CurrentPixel has a different
value than CurrentPixel)
THEN

MARK CurrentPixel IN EdgeMap

ELSE

CONTINUE

END IF

END FOR

The marking process determines whether specific pixels are affected during a final step of anti-aliasing or smoothing out jagged edges in the image.

In an embodiment, the Edge Map's bit depth can be 1 bit, because it stores only TRUE/FALSE values indicating whether corresponding pixels should be anti-aliased or not. In an alternate embodiment, the Edge Map can be combined with the Region Map for more efficient storing. For example, a combined map with the bit depth of 32 bits can be used. The map allocates 31 bits for the Region Map and 1 bit for the Edge Map.

Step 3: Applying Anti-Aliasing to the Marked Pixels.

In the final step, an anti-aliased image is generated using the modified image function, as shown in FIG. 2d. In this step, the pixels of the non-anti-aliased image (shown in FIG. 2a) generated in Step 1 are anti-aliased based on the Edge Map (shown in FIG. 2c) generated in Step 2. The pixels are selected for anti-aliasing according to the following condition: if a pixel is marked in the Edge Map, the corresponding pixel in the non-anti-aliased image will be anti-aliased.

Therefore, the present invention does not apply anti-aliasing to all pixels of the image, thus, saving computational time. The amount of saved time depends on the percentage of marked pixels in the Edge Map.

In an embodiment, the anti-aliasing process can involve conventional super-sampling or other applicable anti-aliasing methods. When selecting an anti-aliasing method, it should be taken into account that one sample of the modified image function is already evaluated and stored in the non-anti-aliased image, generated in Step 1 above. This can be incorporated into the rendering algorithm to save computational time. For example, if a symmetric regular-grid super-sampling kernel with 9 samples per pixel is used, then only 8 samples need to be calculated to anti-alias a pixel, because a central sample is already evaluated.

In an alternate embodiment, if an adaptive super-sampling is used, then the RegionID values can be utilized as criteria for further subdivision of image pixels (along with any color difference parameters). Hence, if samples of the modified image function return different RegionIDs for adjacent subpixels, the subpixels should be further subdivided.

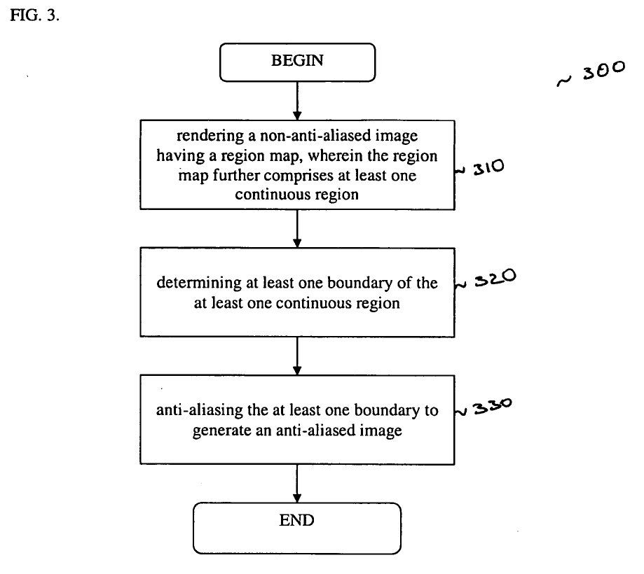

FIG. 3 illustrates a method 300 for generating an anti-aliased image shown in FIG. 2d, according to the present invention. The method begins with step 310. In step 310, the method renders a non-anti-aliased image having a Region Map, as described above. The Region Map further includes at least one continuous region. Then, the processing proceeds to step 320.

In step 320, the method determines at least one boundary of the at least one continuous region within the Region Map. The region is determined in step 310 above. Then, the processing proceeds to step 330.

In step 330, the method applies anti-aliasing to the boundaries of the continuous regions. Such application generates the anti-aliased image.

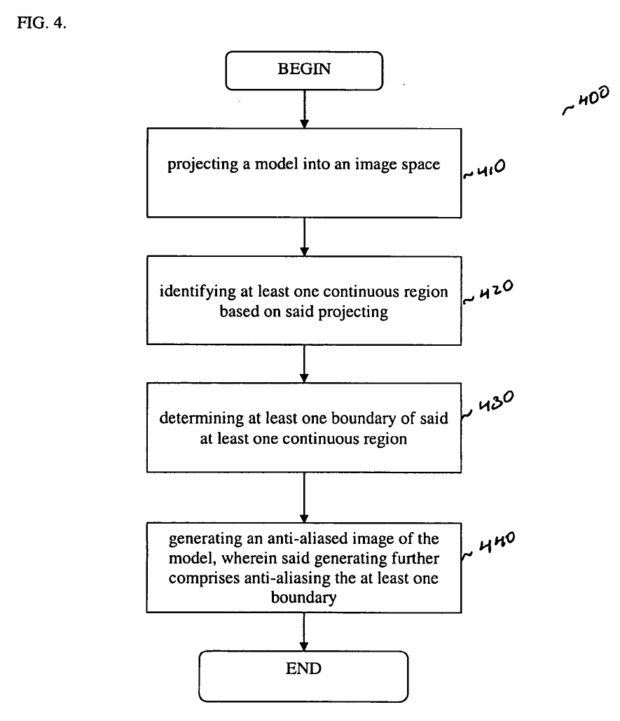

FIG. 4 illustrates an alternate embodiment of the method 400 for generating an image of an object or a model, according to the present invention. The method begins with step 410. In step 410, the method projects the model into an image space. Then, the processing proceeds to step 420.

In step 420, the method identifies at least one continuous region based on the projecting performed in step 410. In an embodiment, the continuous regions can be represented in the Region Map of an image, as described above. The processing proceeds to step 430.

In step 430, the method determines at least one boundary of the at least one continuous region. The boundaries are caused by discontinuities, which cause the image to appear uneven and jagged at these boundaries, as shown in FIGS. 1a and 2a. Then, the processing proceeds to step 440.

In step 440, the method generates an anti-aliased image of the object or the model. The generation step further includes anti-aliasing at least one boundary of the continuous regions. After anti-aliasing the boundaries, the edges in the image appear smoother and undistorted.

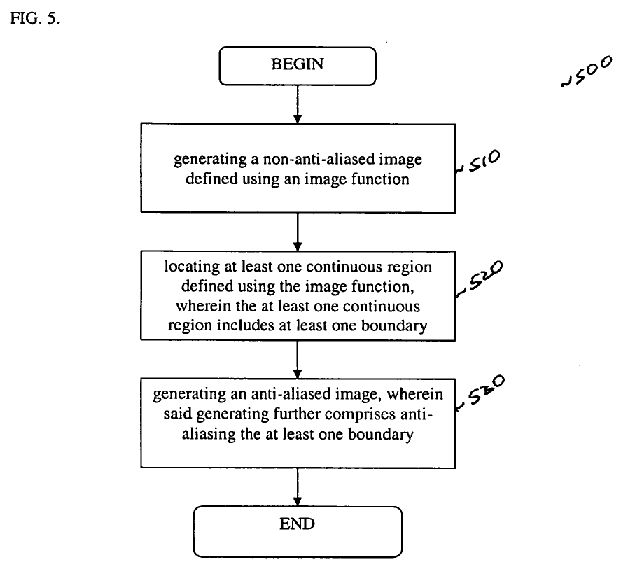

FIG. 5 illustrates yet another alternate embodiment of a method 500 for generating an anti-aliased image shown in FIG. 2d, according to the present invention. The processing begins with step 510, where the method generates a non-anti-aliased image. The non-anti-aliased image is defined by an image function. In an embodiment, the image function is modified, as described above with respect to FIGS. 2a-d. The image includes uneven or distorted edges, as shown in FIGS. 1a and 2a. Then, the processing proceeds to step 520.

In step 520, the method locates at least one continuous region within the image, which is defined using the image function. The at least one continuous region includes at least one boundary. The boundaries typically appear uneven and distorted before the anti-aliasing techniques are applied to them. The processing then proceeds to step 530.

In step 530, the method generates an anti-aliased image from the non-anti-aliased image rendered in step 510. The generating includes anti-aliasing the at least one boundary located in step 520. As a result, the method produces an anti-aliased image having smoother or undistorted edges.

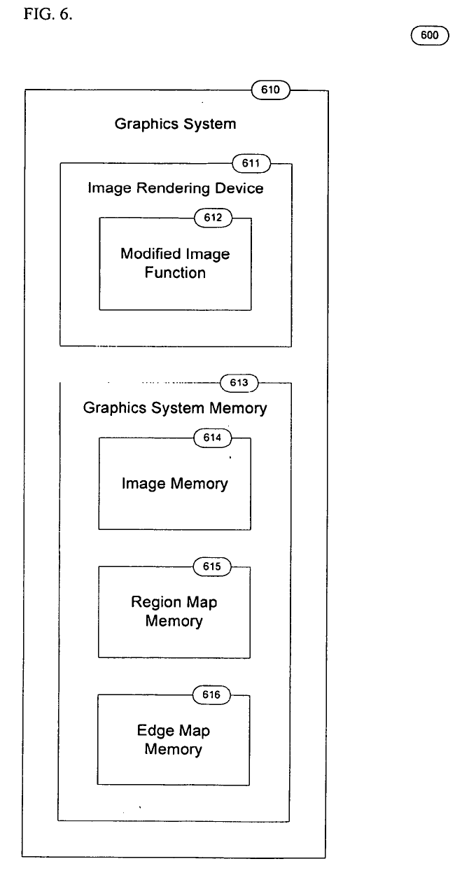

FIG. 6 illustrates an embodiment of a system 600 configured to generate anti-aliased images such as those shown in FIGS. 1b and 2d. The system 600 includes a graphics system 610 that further includes an image rendering device 611 and a graphics system memory 613. In an embodiment, the system 600 can be any computer system that can include processing and/or Input/Output device(s).

The image rendering device 611 further includes a modified image function 612. The graphics system memory 613 further includes an image memory 614, a Region Map memory 615, and an Edge Map memory 616.

Using the image rendering device 611, the graphics system 610 generates an image in the image memory 614, wherein the image is defined by the modified image function 612.

Using the modified image function 612, the rendering device 611 generates a non-anti-aliased image, which is stored by the graphics system memory 613 in the image memory 614; and a Region Map, which is stored by the graphics system memory 613 in the Region Map memory 615. As stated above, the Region Map represents continuous regions within the image. The Region Map is used to generate an Edge Map (shown in FIG. 2c) for the non-anti-aliased image which is stored in the image memory 614. The Edge Map is stored in the Edge Map memory 616.

Using the values stored in the Edge Map memory 616, the system 600 applies anti-aliasing to the boundaries of the continuous regions to generate an anti-aliased image in the image memory 614. An alternate embodiment can include a separate storage for the non-anti-aliased image and the anti-aliased image.

Example embodiments of the methods and components of the present invention have been described herein. These example embodiments have been described for illustrative purposes only, and are not limiting. Other embodiments are possible and are covered by the invention. Such embodiments will be apparent to persons skilled in the relevant art(s) based on the teachings contained herein. Thus, the breadth and scope of the present invention should not be limited by any of the above-described exemplary embodiments, but should be defined only in accordance with the following claims and their equivalents.

What is claimed is:

1. A method for generating an image, comprising the steps of:
a) rendering a non-anti-aliased image having a region map, wherein the region map further comprises at least one continuous region;
b) determining at least one boundary of the at least one continuous region; and
c) anti-aliasing the at least one boundary to generate an anti-aliased image.

2. The method of claim 1, wherein said image is defined by an image function.

3. The method of claim 2, wherein said image function is modified to generate said region map; and
wherein said region map further comprises at least one discontinuity.

4. The method of claim 3, wherein said discontinuity is defined by at least one conditional statement in said image function.

5. The method of claim 4, wherein said discontinuity is adjacent to a plurality of pixels.

6. The method of claim 5, wherein said anti-aliasing step further comprises anti-aliasing said plurality of pixels.

7. A method for generating an image of a model, comprising the steps of:
a) projecting a model into an image space;
b) identifying at least one continuous region based on said projecting;
c) determining at least one boundary of said at least one continuous region; and
d) generating an anti-aliased image of the model, wherein said generating further comprises anti-aliasing the at least one boundary.

8. The method of claim 7, wherein said projecting step further comprises generating an image of said model defined by a modified image function;
wherein said image is defined by a plurality of pixels in said image space.

9. The method of claim 8, wherein said identifying step further comprises identifying at least one discontinuity, wherein said discontinuity is defined by at least one conditional statement in said modified image function.

10. The method of claim 9, wherein said at least one boundary is defined by said at least one conditional statement.

11. The method of claim 10, wherein said at least one boundary is adjacent to a plurality of pixels in said image space.

12. The method of claim 11, wherein said anti-aliasing step further comprises selecting a plurality of pixels adjacent to said at least one boundary; and anti-aliasing said selected plurality of pixels.

13. A computer system for anti-aliasing an image, comprising:
a) a means for generating a non-anti-aliased image defined using an image function;
b) a means for locating at least one continuous region defined using the image function, wherein the at least one continuous region comprises at least one boundary; and
c) a means for generating an anti-aliased image, wherein said generating further comprises anti-aliasing the at least one boundary.

14. The system of claim 13, wherein said image function generates a region map further comprising at least one continuous region within an image.

15. The system of claim 14, wherein said region map further comprises at least one discontinuity.

16. The system of claim 15, wherein said discontinuity is defined by at least one conditional statement in said image function.

17. The system of claim 16, wherein said discontinuity is adjacent to a plurality of pixels.

18. The system of claim 17, wherein said means for generating said anti-aliased image further comprises a means for anti-aliasing said plurality of pixels.
